(19) United States
(12) Patent Application Publication
(10) Pub. No.: US 2025/0131189 A1
(43) Pub. Date: Apr. 24, 2025

(54) PERSONALIZED STYLIZING LARGE LANGUAGE MODEL WRITING ASSISTANT

(71) Applicant: Microsoft Technology Licensing, LLC, Redmond, WA (US)

(72) Inventors: Tara SAFAVI, Seattle, WA (US); Sheshera Shashidhar Mysore, Belchertown, MA (US); Longqi Yang, Issaquah, WA (US); Mengting Wan, Bellevue, WA (US); Jennifer Lynay Neville, West LaFayette, IN (US); Steve S. Menezes, Redwood City, CA (US)

(21) Appl. No.: 18/381,956

(22) Filed: Oct. 19, 2023

(51) Int. Cl. G06F 40/20

(52) U.S. Cl. CPC G06F 40/20

(57) ABSTRACT

Personally-stylized content can be generated without fine tuning a model. A personally-stylized content generation method can include receiving a first request for first content to be stylized in a style of written prose previously produced by a user, applying a previously trained retriever model to the first request to obtain second content previously produced by the user resulting in obtained content, populating a prompt with the obtained content and the first request resulting in an augmented prompt, providing the augmented prompt to a large language model (LLM), receiving personally-stylized content from the LLM, the personally-stylized content including elements of the style of the written prose of the user, and providing the personally-stylized content to the user.

### BACKGROUND

The common way to make a large language model (LLM) generate content in the vocabulary and writing style of a user is to fine tune the model. In fine tuning, content generated by the user is used to further train the LLM. The further training provides the LLM with an understanding of the vocabulary and writing style of the user. With the understanding of the vocabulary and the writing style of the user, the LLM can generate content that includes the vocabulary and the writing style of the user.

### SUMMARY

Instances regard circuits, devices, and methods for generating personally-stylized content. The instances can proceed without fine tuning of a generative LLM. The instances can operate by including prior content that is informative of a content generation style of a user in a prompt to the generative LLM.

A personally-stylized content generation method can include receiving a first request for first content to be stylized in a style of written prose previously produced by a user. A previously trained retriever model can be applied to the first request to obtain second content previously produced by the user resulting in obtained content. A prompt can be populated with the obtained content and the first request resulting in an augmented prompt. The augmented prompt can be provided to a large language model (LLM). Personally-stylized content can be generated by the LLM and provided to the user.

The retriever model can be trained by generating, by a language model (LM) and based on target content that is stylized in the voice of the user, content previously generated by the user, and a second request for the target content, a first score indicating how much the previously generated content will help the LLM in generating the target content. The retriever model can be altered based on the first score. Training the retriever model can further include generating, by the LM and based on the target content that is stylized in the voice of the user and the second request for the target content, a second score indicating how well the LLM can generate the target content based on just the second request. Altering the retriever model can include altering the retriever model based on the first score and the second score. Training the retriever model can further include generating, by the retriever model and based on the second request and the content previously generated by the user, a third score. The retriever model can be altered based on a loss that considers (i) the third score and (ii) a fourth score that is a difference between the first score and the second score. Altering the retriever model can include using a relative entropy loss function. The relative entropy loss function can operate based on calibrated third scores and fourth scores that helps ensure the third score is predictive of how well the previously generated content will help the generative language generate the personally-stylized content. The calibrated third scores can include all the scores corresponding to the historical content and an additional zero score.

The second request can be reverse engineered based on the target content resulting in training or testing data. The LLM can be a generative LLM. The retriever model can be an encoder model. The personally-stylized content can include emulation of a writing style or communication style in the second content.

A personally-stylized content generation system can include a database storing content items previously generated by users. The system can include a pre-trained retriever model configured to receive, from a user, a query for personally-stylized content. The pre-trained retriever model can be further configured to score each item of content generated by the user in the database. The pre-trained retriever model can be further configured to provide a specified number of content items that were previously generated by the user and associated with highest scores. The system can further include a prompt augmenter configured to receive the specified number of content items. The prompt augmenter can be further configured to augment a prompt to include content of the specified number of content items resulting in an augmented prompt. The prompt augmenter can be further configured to provide the augmented prompt to a large language model (LLM). The system can further include an application configured to provide, to the user, personally-stylized content from the LLM responsive to the augmented prompt.

The system can further include a language model configured to generate, based on target content that is stylized in a voice of the user, content previously generated by the user, and a second request for the target content, a first score indicating how much the previously generated content will help the LLM in generating the target content. The language model can be further configured to generate, based on the target content that is stylized in the voice of the user and the second request for the target content, a second score indicating how well the LLM can generate the target content based on just the second request. The retriever model can be further configured to generate, based on the second request and the content previously generated by the user, a third score. The system can further include a compute device configured to alter the retriever model based on a difference between (i) the third score and (ii) a difference between the first score and the second score.

A machine-readable medium can be configured to implement operations of the method, system, or a portion thereof.

### BRIEF DESCRIPTION OF THE DRAWINGS

FIG. 1 illustrates, by way of example, a diagram of an embodiment of a system for personalized stylizing of content.

FIG. 2 illustrates, by way of example, a diagram of an embodiment of training a retriever model to generate a trained retriever model.

FIG. 3 illustrates, by way of example, a diagram of an embodiment of a method for personalized stylizing of content.

FIG. 4 is a block diagram of an example of an environment including a system for neural network (NN) training.

FIG. 5 is a block schematic diagram of a computer system for performing methods and algorithms according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Personally stylized content from a large language model (LLM) may be generated by fine tuning the LLM. The fine tuning of the LLM is overly cumbersome and impractical for a common, non-famous user.

Personalized stylizing of content can be accomplished without fine tuning or otherwise changing the LLM. Improved personalized stylizing can be accomplished by augmenting a prompt provided to the LLM. The augmentation of the prompt can include providing content that was previously produced by the user (sometimes called “historical content”). The historical content can be filtered to include the historical content that is deemed most important for learning the style of the user. The filtering of the historical content can include leveraging a retriever model that is trained to rank the historical content. The rank can be based on an amount the content will benefit personalization.

As used herein, “style” includes word choice, sentence structure, spelling, grammar, punctuation usage, paragraph structure, or the like. Writing style includes the choice of words, grammar, punctuation usage, sentence structure, and paragraph structure, used to convey meaning. A communicator has great flexibility in how to express a concept and style is the elements that capture how the communicator chooses to convey the message.

The retriever model can be trained using historical content and queries. A query associated with the target content can be reverse engineered such that, if the query were provided to the LLM, the LLM would generate the target content.

A loss function used in training the retriever model can receive multiple scores as input. The scores can indicate how much the given historical post will help the LLM generate the target post. During training, a target score can be determined based on a first score and a second score generated by a language model (LM). The LM is different from the retriever model and the LLM. The LM can determine a first score based on the target post, historical posts, and the query. The first score can indicate how likely it is the target post will be generated given the query and a historical post. The second score can indicate how likely it is the target post will be generated given just the query. A higher difference between the first score and the second score thus indicates how much the historical content will benefit the personalization of generating target content. By training the retriever model to reproduce a score that is the difference between the first score and the second score, the retriever model is trained to produce scores for historical posts that indicate how much the historical posts will benefit the LLM in generating a target post to fulfill a query.

The highest scoring historical posts can be used to augment a prompt. The prompt can be generated to include the query and the historical posts. The prompt can be provided to the LLM. The LLM then provides content generated in the style of the user based on the prompt. This provides a personalized stylizing of content that does not rely on fine tuning or other alteration of the LLM.

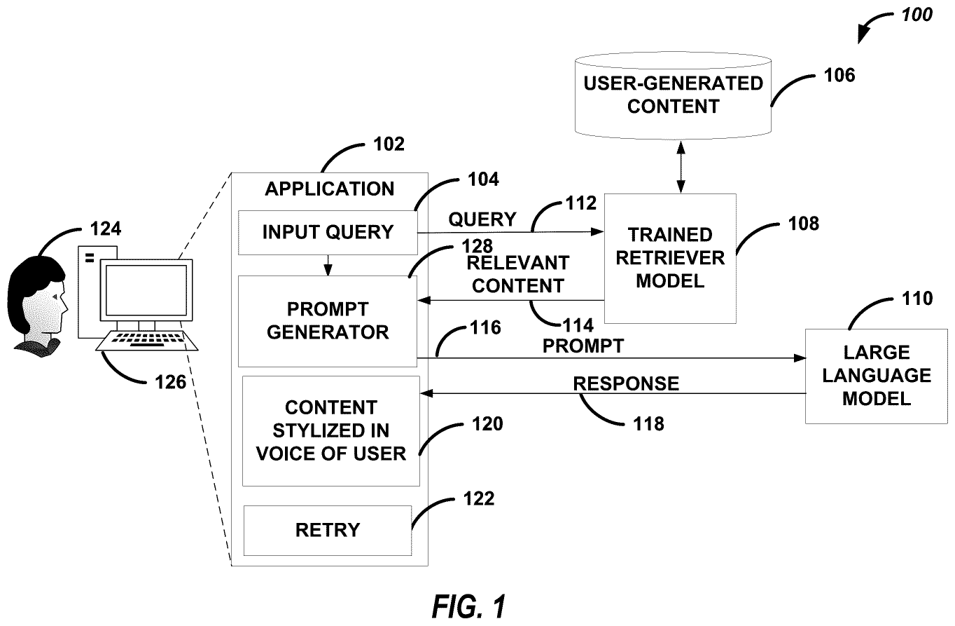

FIG. 1 illustrates, by way of example, a diagram of an embodiment of a system 100 for personalized stylizing of content. The system 100 as illustrated includes a personalized stylizing application 102 communicatively coupled to a trained retriever model 108 and an LLM 110. The trained retriever model 108 is communicatively coupled to a user-generated content database 106.

A user 124, through a compute device 126, interacts with the application 102. The user 124 generates an input query 104 for personalized stylizing of content. In some instances, the application 102 can be dedicated to generating personally-stylized content. That means, the user 124 does not need to expressly indicate that the content to be generated is the be personally-stylized. In such instances, all inputs into an input query control 104 are assumed to be requests for personally-stylized content. In other instances, the application 102 can be more general purpose and the user 124 can select or otherwise indicate that they desire the content to be generated to mimic their personal style.

The compute device 126 can be a laptop computer, desktop computer, smartphone, smart appliance, smartwatch, or other device capable. The compute device 126 is capable of executing the application 102. The compute device 126 can communicate either directly or indirectly with the trained retriever model 108 and the LLM 110.

The application 102 executes to provide the user 124 with access to personally-stylized content. The application 102 includes an input query control 104, a prompt generator 128, an output region 120 that provides content stylized in the style of the user 124 (sometimes called “personally stylized content”), and a retry control 122. The controls 104 and 122 are software controls. The user 124 can interact with the software controls to provide input to the application 102. The style of the user can include the vocabulary of content generated by the user, the formality of content generated by the user, punctuation use by the user in the generated content, whether the user is rigorous about spelling, or the like.

The input query control 104 receives a query 112 as input from the user 124. The query 112 indicates personally stylized content the user 124 wants generated. The query 112 can be for a social media post, an email, a paragraph for a paper, or other content for which there is sufficient historical content examples. An artist, for example, can generate a query 112 to generate an image in their own style. An influencer, for example, can generate a query 112 to generate a social media post for a product. An example query is “write a post to share my upcoming cross-team networking event in Building X at 5-7 pm on Oct. 11, 2023”

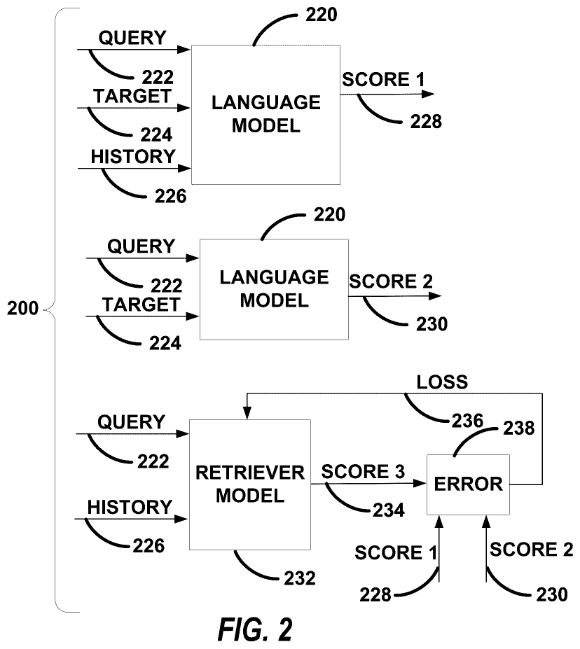

The query 112 is provided to the trained retriever model 108. Training of the trained retriever model 108 is discussed regarding FIG. 2. The trained retriever model 108 is an encoder model that scores content generated by the user 124. The content generated by the user 124 is stored in a database 106. The database 106 can be indexed by author, such that a search for the user 124 provides content generated by the user 124. The trained retriever model 108 can score the user-generated content based on how much the content will help the LLM 110 understand the style of the user 124. The score generated by the trained retriever model 108 can be higher for content that is more helpful in capturing the style of the user 124 given the query 112 and lower for content that is less helpful in understanding the style of the user 124 given the query 112, or vice versa.

The trained retriever model 108 ranks the user-generated content by score. The trained retriever model 108 returns a specified number of user-generated content items as relevant content 114. The specified number is configurable. In practice, about three to four historical posts is sufficient to capture the vocabulary and writing style of the user 124. The trained retriever model 108 can provide the relevant content 114 to the application 102. An example trained retriever model 108 is bidirectional encoder representations from transformers (BERT) from Google LLC of Mountain View, California, United States, robustly optimized BERT training approach (RoBERTa) from Meta of Menlo Park, California, United States, or another encoder model.

A prompt generator 128 of the application 102 generates a prompt 116 based on the query 112 and the relevant content 114. The prompt 116 can include portions that are used by the LLM 110 in generating a response 118 that includes content stylized in the voice of the user 124 (“personally-stylized content”). The personally-stylized content can be presented to the user 124 in an output control 120. The portions of the prompt 116 can include a generative language model instruction, the user-generated content provided by the trained retriever model 108, the query 112, and a summary. An example prompt 116 is provided, note the different headings in BOLD are not typically included in the prompt but are provided for edification:

LLM INSTRUCTION: Given a REQUEST from a USER to author a POST, write a POST for an enterprise social media site mimicking the user to satisfy the REQUEST.

Use the following instructions for your response:

1. You should maintain consistency in tone and style with the USER's historical posts.

2. You imitate the language style of the USER's historical posts.

3. You should employ similar rhetorical methods as the USER's historical posts.

USER-GENERATED CONTENT: Here are some historical posts by the USER:

Post: Hey team! 5 days left in Q1/FY22. Let's work together to finish the quarter strong! In working on your close plans, I highly recommend you watch the recording from . . . .

QUERY: REQUEST: Write a post reminding the team to watch a 2 minute video about compliance to company policies.

SUMMARY: Write the POST to satisfy the REQUEST mimicking the tone, style, and rhetorical methods of the USER's historical posts.

One or more of the language or ordering of portions of the example prompt 116 can be changed . . . .

The LLM 110 generates the response 118 based on the prompt 116. The LLM 110, without fine-tuning, provides content stylized in the voice of the user to satisfy the query 112. The LLM 110 includes a large language model (LLM), such as generative pre-trained transformer (GPT) 3 (GPT-3) or GPT-4 from OpenAI, Inc., large language model Meta AI (LLaMA) from Meta of Menlo Park, California, United States, and (pathways language model) 2 (PaLM2) from Google LLC of Mountain View, California, United States, among others.

The user 124 can consume the response 118 by reading it in the output control 120. If the user 124 does not like the response 118, the user 124 can select a retry software control 122. Responsive to the user 124 selecting the retry software control 122, the prompt generator 128 can generate a new prompt 116. The new prompt 116 can include the original prompt with additional information including the response 118. An example new prompt 116 can be formatted as: “Given a REQUEST and a DRAFT from a USER to author a social media POST, edit the DRAFT mimicking the USER's historical posts to satisfy the REQUEST.

Use the following instructions for your response:

1. You should maintain consistency in tone and style with the USER's historical posts.

2. Remove redundant information from the DRAFT.

3. Output the edited DRAFT starting with the words EDITED DRAFT.

Here are some historical posts by the USER:
{historical_examples}
{target_input}

### DRAFT:

Pretend to be the USER and output the edited DRAFT to satisfy the REQUEST starting with the words EDITED DRAFT.”

Content in the database 106 can be filtered to include only users with a specified number of content samples that meet specified criterion. There are a lot of examples of the criterion and the following example is just one set of criterion and specified number of content samples that works well. One example of criterion that works for social media content is filtering the users to only those that have fifteen or more social media posts that are fifty or more words long and have more than two comments.

FIG. 2 illustrates, by way of example, a diagram of an embodiment of training a retriever model 232 to create the trained retriever model 108. The retriever model 232 is being trained to generate a score 234 for each item of historical user-generated content 226. The score 234 indicates how much the given content 226 will help the LLM 110 (usually different from a language model 220).

The training of the retriever model 232 begins by generating scores 228, 230 using the language model 220. A first score 228 is generated based on a query 222, a target content 224, and historical user-generated content 226. The first score 228 represents how much a response to the query 222 can benefit from personalized stylizing. In mathematical terms, the first score 228 is determined as first score=LM (query, content_{target}, contentₕᵢₛₜ)=(content_{target}|query, contentₕᵢₛₜ).

A second score 230 can be generated by a same language model 220. In FIG. 2, the scores 228, 230 are generated by the same language model 220. The second score 230 can be generated based on the query 222 and the target content 224. The second score 230 indicates how well the target content 224 can be generated without personalized stylizing. In mathematical terms, the second score 230 is determined as second score=LM (query, content_{target})=(content_{target}|query). A difference between the first score 228 and the second score 230 (e.g., first score−second score) indicates how much the historical content 226 will help in personalized stylizing of the content.

An example of a model that can be used as the language model 220 is a text-to-text-transformer-transformer (T5) model from Google LLC. Other models that can be used as the language model 220 include generative language models, such as ChatGPT, GPT-3, GPT-4, or other language models. A generative language model is generally quite expensive to operate in terms of compute bandwidth, compute complexity, power consumed, among other cost parameters. The power of the generative language model is generally more than is required for generating the scores 228, 230 so a lighter weight, less complex model, less costly model to operate can be used to generate the scores 228, 230.

The retriever model 232 can then be trained, in a supervised manner, to generate a third score 234 that mimics a difference between the first score 228 and the second score 230. The retriever model 232 can receive a query 222 and an individual item of historical content 226. The retriever model 232 can predict the third score 234 based on the query 222 and the historical content 226. An error operator 238 can determine a loss 236 based on the third score 234 and a difference between the first score 228 and the second score 230. The loss 236 can be a modified Kullback-Leibler (KL) divergence. The KL divergence is a measure of how much one probability distribution differs from another probability distribution. The modified KL divergence can include the KL divergence with additional terms that help ensure that the (i) difference between the first score 228 and the second score 230 and (ii) the third score 234 are predictive of how much the user-generated content 226 will help in personalized stylized of content.

A common KL divergence loss function is:

$$KL ( \{ y , s \} ) = {Σ}_{i ∈ D} [ \frac{exp ( {y}_{i} )}{{Σ}_{j ∈ D} ( exp ( {y}_{j} )} log ( exp ( {s}_{i} ) / {Σ}_{j ∈ D} ( exp ( {s}_{j} ) ) )$$

An example of the modified, scale-calibrated KL divergence loss function is:

$$K {L}_{mod} ( \{ {y}^{′} , {s}^{′} \} ) = - {\sum }_{i ∈ D} [ \frac{exp ( {y}_{i} )}{{Σ}_{j ∈ D} ( exp ( {y}_{j} ) ) + exp ( {y}_{o} )} log \frac{exp ( {s}_{i} )}{{Σ}_{j ∈ D} ( exp ( {s}_{j} ) ) + 1} ] + \frac{exp ( {y}_{0} )}{{Σ}_{j ∈ D} ( exp ( {y}_{j} ) ) + exp ( {y}_{o} )} log ( {\sum }_{j ∈ D} ( exp ( {s}_{j} ) ) + 1 )$$

Where D represents the set of historical content, y is the target scores (the difference between the first score 228 and the second score 230), and s is the score predicted by the retriever model 232 (the third score 234). Calibration can be achieved by including an extra “anchor” training example with a fixed ranking score s₀=0 and a target score y₀, which is trainable and serves as a reference for calibration. In an example with three historical posts, the extra terms lead to y′={y₁, y₂, y₃, y₀} and s′={s₁, s₂, s₃, 0}. Including the fourth terms in y′ and s′ transforms the distribution of scores generated by the retriever model 110 so that the extreme scores (very high values or very low values) are driven closer to the median. In practice, this helps avoid over-estimating and avoid under-estimating utility of a historical post due to the scores being too extreme, making the scores more reflective of utility.

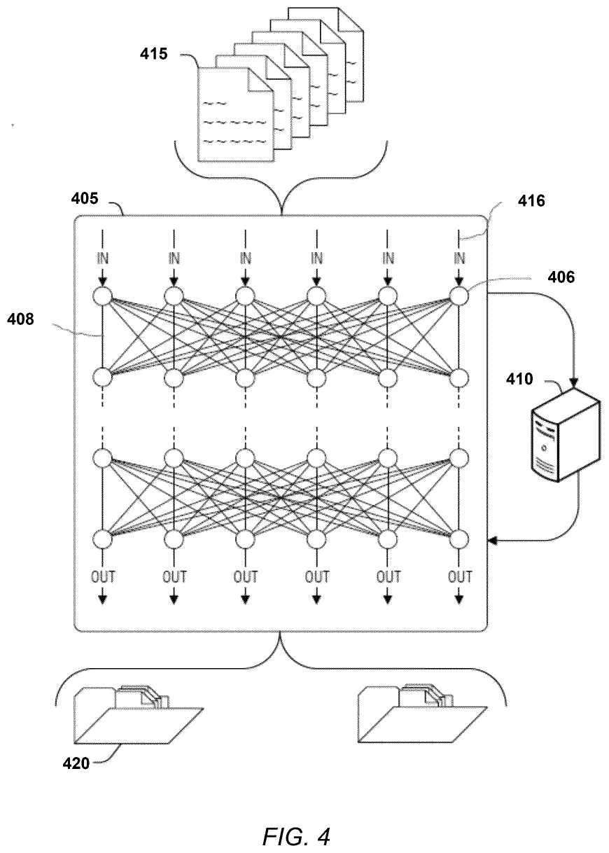

More details on training a model are provided regarding FIG. 4. The result of training the retriever model 232 in this way is the trained retriever model 108.

To begin training, the query 222 is typically not readily available. The historical content generated by the user 124 is typically manually provided by the user 124 and is typically not the result of a query. Thus, the query 222 can be generated based on the target content 224. The query 222 can be generated manually or by another model, such as a generative language model.

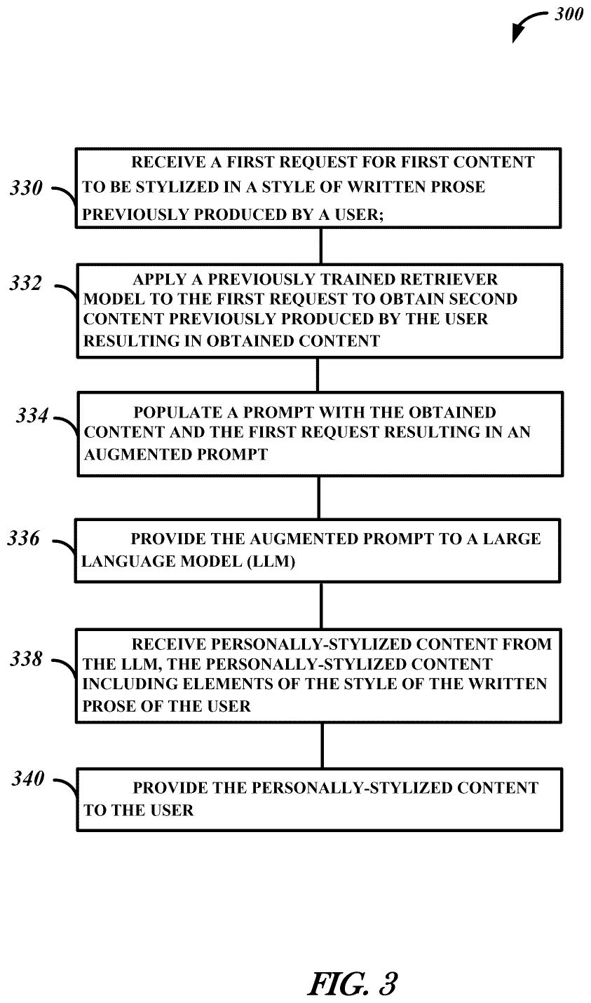

FIG. 3 illustrates, by way of example, a diagram of an embodiment of a method 300 for personalized stylizing of content. The method 300 as illustrated includes receiving a first request for first content to be stylized in a style of written prose previously produced by a user, at operation 330; applying a previously trained retriever model to the first request to obtain second content previously produced by the user resulting in obtained content, at operation 332; populating a prompt with the obtained content and the first request resulting in an augmented prompt, at operation 334; providing the augmented prompt to a large language model (LLM), at operation 336; receiving personally-stylized content from the LLM, the personally-stylized content including elements of the style of the written prose of the user, at operation 338; and providing the personally-stylized content to the user, at operation 340.

The method 300 can further include training the retriever model by generating, by a language model (LM) and based on target content that is stylized in the voice of the user, content previously generated by the user, and a second request for the target content, a first score indicating how much the previously generated content will help the LLM in generating the target content. Training the retriever model can further include altering the retriever model based on the first score. Training the retriever model can further include generating, by the language model and based on the target content that is stylized in the voice of the user and the second request for the target content, a second score indicating how well the LLM can generate the target content based on just the second request. Altering the retriever model can further include altering the retriever model based on the first score and the second score. Training the retriever model can further include generating, by the retriever model and based on the second request and the content previously generated by the user, a third score. Altering the retriever model can be performed based on a loss that considers (i) the third score and (ii) a fourth score that is a difference between the first score and the second score. Altering the retriever model can include using a relative entropy loss function. The relative entropy loss function can operate based on calibrated third scores and fourth scores that helps ensure the third score is predictive of how well the previously generated content will help the generative language generate the personally-stylized content. The calibrated third scores can include all the scores corresponding to the historical content and an additional zero score.

The second request can be reverse engineered based on the target content resulting in training or testing data. The LLM can include a generative LLM. The retriever model can include an encoder model. The personally-stylized content includes emulation of a writing style or communication style in the second content.

Using the system 100 or the method 300, content can be personally stylized. An example of a request, historical content, and content generated without personal-stylizing and content generated with personalized stylizing are provided. The request was provided as input to a generative language model without historical content to generate the content without personal-stylizing. The request was provided as input to the system 100 to generate the content with personal-stylizing.

### Example Target Content:

Happy Friday! Friendly reminder that the 2023 Remote Work Habits survey is now OUT and that means you, yes you, can participate for a chance to win a $100 GIFT CARD redeemable at ANY of the Microsoft Redmond campus cafeteries! Yes that's right, spend 10 minutes of your time filling out this survey about how you work effectively from home and in exchange eat for free for weeks! Responses must be received by April 12th to qualify for drawing. Thanks for your time!

Example Request:

Encourage audience to participate in 2023 Remote Work Habits survey and get the chance to win a $100 gift card redeemable at any of the Microsoft Redmond on-campus cafeterias. Responses must be received by April 12th.

Non-Personalized Content (Content generated using non-personalized system):

We want to hear from you! Take part in our 2023 Remote Work Habits survey and you could win a $100 gift card redeemable at any of the Microsoft Redmond on-campus cafeterias. Don't miss out on this chance to share your thoughts and be rewarded! Responses must be received by April 12th. #RemoteWork #Microsoft #Survey #Rewards

Personalized Content (Content generated using the system 100):

Hey everyone! We're excited to announce the 2023 Remote Work Habits survey is now live! By participating, you'll have the chance to win a $100 gift card redeemable at any of the Microsoft Redmond on-campus cafeterias. We want to hear about your experiences working remotely and how we can continue to improve our tools and resources to support you. Don't miss out on this opportunity to share your thoughts and potentially win a delicious meal on us! Responses must be received by April 12th to qualify for the drawing. Thanks for your time and participation!

Notice how the personalized content follows the user's tone and emphasis and is more upbeat while the non-personalized content is more formal and generic and includes unnecessary hashtags.

The system 100 and method 300 were evaluated based on social media posts. Posts and comments were generated based on historical user posts and comments, respectively. Evaluation of personalized-stylizing is challenging because evaluation metrics are typically not suited for long-form text generation, evaluation is generally subjective in that the user 124 satisfaction is subjective and there are several ways to satisfy a user request or query. Further, there are several aspects to performance like determining whether the content is relevant, adherence to style, whether reasoning is consistent, and whether content was successful.

Metrics that were used to evaluate the personalized-styling of content include Rouge-1, Rouge-2, BertScore, Classification F1, and human evaluations. Performance of the retriever model 108 was compared to baselines that include zero-shot LLM prompting, random few-shot examples across all users, random, BM25, SentenceBert-1B, and Query Likelihood.

Table 1 provides a summary of various measures on Viva Engage that compares non-personalized styling with personalized styling. For the personalized styling approaches several retrievers are compared on a curated set of 163 Viva Engage posts using text generation metrics BERTScore, Rouge1, and Rouge2.

TABLE 1
Baselines vs Calibrated Crossencoder
with GPT-3.5 on Viva Engage.

| | Method | BERTScore | Rouge-1 | Rouge-2 |
|---|---|---|---|---|
| Non- | k = 0, GPT-3.5 | 0.3625 | 0.5029 | 0.2516 |
| Personalized | k = 1, GPT-3.5 | 0.3408 | 0.4931 | 0.2431 |
| LLM | | | | |
| Retrieval + | Random + GPT-3.5 | 0.3504 | 0.5036 | 0.2505 |
| LLM | | | | |
| | BM25 + GPT-3.5 | 0.3796 | 0.5287 | 0.2911 |
| | SentBERT1B + | 0.3830 | 0.5281 | 0.2931 |
| | GPT-3.5 | | | |
| | QL-T5Base + | 0.3870 | 0.5337 | 0.3019 |
| | GPT-3.5 | | | |
| | Retriever model | 0.3960 | 0.5419 | 0.3094 |
| | 108 with | | | |
| | calibration term + | | | |
| | GPT-3.5 | | | |

Table 2 provides a summary of various measures on Viva Engage. For the personalized styling approaches several retrievers are compared on a curated set of 163 Viva Engage posts using text generation metrics BERTScore, Rouge1, and Rouge2.

TABLE 2
Baselines vs Calibrated Crossencoder
with GPT-3.5-Turbo on Viva Engage.

| | Method | BERTScore | Rouge-1 | Rouge-2 |
|---|---|---|---|---|
| Non- | k = 0, GPT3.5- | 0.3103 | 0.4627 | 0.2091 |
| Personalized | Turbo | | | |
| LLM | k = 1, GPT3.5- | 0.3251 | 0.4825 | 0.2258 |
| | Turbo | | | |
| Retrieval + | Random + | 0.3346 | 0.4893 | 0.2345 |
| LLM | GPT3.5-Turbo | | | |
| | BM25 + GPT3.5- | 0.3657 | 0.5089 | 0.2673 |
| | Turbo | | | |
| | SentBERT1B + | 0.3602 | 0.5063 | 0.2639 |
| | GPT3.5-Turbo | | | |
| | QL-T5Base + | 0.3598 | 0.5054 | 0.2642 |
| | GPT3.5-Turbo | | | |
| | Retriever model | 0.3649 | 0.5082 | 0.2676 |
| | 108 with | | | |
| | calibration term + | | | |
| | GPT3.5-Turbo | | | |

Table 3 provides a summary of ablations of the personalized styling system with GPT-3.5 on Viva Engage.

TABLE 3
Ablating Calibrated Crossencoders with GPT-3.5 on Viva Engage.

| Method | BERTScore | Rouge-1 | Rouge-2 |
|---|---|---|---|
| Retriever model 108 with | 0.3960 | 0.5419 | 0.3094 |
| calibration term + GPT-3.5 | | | |
| Retriever model 108 | 0.3888 | 0.5350 | 0.3033 |
| without calibration term + | | | |
| GPT-3.5 | | | |
| P(target\|query, historical) + | 0.3934 | 0.5359 | 0.3059 |
| GPT-3.5 | | | |
| Cross Encoder + GPT-3.5 | 0.3781 | 0.5288 | 0.2953 |

Table 4 provides a summary of ablations of the personalized styling system with GPT-3.5-Turbo on Viva Engage.

TABLE 4
Ablating Calibrated Crossencoders
with GPT-3.5-Turbo on Viva Engage.

| Method | BERTScore | Rouge-1 | Rouge-2 |
|---|---|---|---|
| Retriever model 108 with | 0.3649 | 0.5082 | 0.2676 |
| calibration term + GPT- | | | |
| 3.5-Turbo | | | |
| Retriever model 108 | 0.3669 | 0.5095 | 0.2654 |
| without calibration term + | | | |
| GPT-3.5-Turbo | | | |
| P(target\|query, historical) + | 0.3564 | 0.5057 | 0.2652 |
| GPT-3.5-Turbo | | | |
| Cross Encoder + GPT-3.5- | 0.3599 | 0.5038 | 0.2613 |
| Turbo | | | |

Table 5 provides a summary of various measures on Viva Engage.

TABLE 5
Routing with Calibrated Cross Encoders
with GPT-3.5 on Viva Engage.

| | | BERTScore | Rouge- | Rouge- | Routed |
|---|---|---|---|---|---|
| | Method | F1 | 1 | 2 | (%) |
| Retrieval + | BM25 + GPT- | 0.3820 | 0.5277 | 0.2904 | — |
| LLM | 3.5 | | | | |
| Retrieval + | | 0.3871 | 0.5288 | 0.2914 | 100 |
| LLM + Edit | | | | | |
| Routing | | 0.3899 | 0.5320 | 0.2958 | 68 |
| to Editing | | | | | |
| Retrieval + | Retriever | 0.3913 | 0.5399 | 0.3054 | — |
| LLM | model 108 | | | | |
| Retrieval + | with | 0.3901 | 0.5376 | 0.3027 | 100 |
| LLM + Edit | Calibration | | | | |
| | Term + | | | | |
| Routing | GPT-3.5 | 0.3980 | 0.5423 | 0.3103 | 75 |
| to Editing | | | | | |

Table 6 provides a summary of various measures on Viva Engage.

TABLE 6
Routing with Calibrated Cross Encoders
with GPT-3.5-Turbo on Viva Engage.

| | | BERTScore | Rouge- | Rouge- | Routed |
|---|---|---|---|---|---|
| | Method | F1 | 1 | 2 | (%) |
| Retrieval + | BM25 + GPT- | 0.3594 | 0.5041 | 0.2612 | — |
| LLM | 3.5-Turbo | | | | |
| Retrieval + | | 0.3546 | 0.5090 | 0.2604 | 100 |
| LLM + Edit | | | | | |
| Routing | | 0.3670 | 0.5169 | 0.2724 | 63 |
| to Editing | | | | | |
| Retrieval + | Retriever | 0.3679 | 0.5128 | 0.2702 | — |
| LLM | model 108 | | | | |
| Retrieval + | with | 0.3580 | 0.5112 | 0.2639 | 100 |
| LLM + Edit | Calibration | | | | |
| | Term + | | | | |
| Routing | GPT-3.5- | 0.3757 | 0.5264 | 0.2858 | 78 |
| to Editing | Turbo | | | | |

Tables 1 and 2 show that the retriever model 108 with the calibration term helps generation of the content more than other approaches. Tables 3 and 4 show that the retriever model 108 with the calibration term operates with better performance than ablated variants of the system 100 with missing components. Tables 5 and 6 show that modest gains in performance can be achieved by routing underperforming personalized content to a LLM for post editing.

Artificial Intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as classification, device behavior modeling (as in the present application) or the like. The trained retriever model 108, LLM 110, language model 220, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph-if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

FIG. 4 is a block diagram of an example of an environment including a system for neural network (NN) training. The system includes an artificial NN (ANN) 405 that is trained using a processing node 410. The processing node 410 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 405, or even different nodes 406 within layers. Thus, a set of processing nodes is arranged to perform the training of the ANN 405. The trained retriever model 108, LLM 110, language model 220, retriever model 232, or the like, can be trained using the system.

The set of processing nodes is arranged to receive a training set 415 for the ANN 405. The ANN 405 comprises a set of nodes 406 arranged in layers (illustrated as rows of nodes 406) and a set of inter-node weights 408 (e.g., parameters) between nodes in the set of nodes. In an example, the training set 415 is a subset of a complete training set. Here, the subset may enable processing nodes with limited storage resources to participate in training the ANN 405.

The training data may include multiple numerical values representative of a domain, such as an image feature, or the like. Each value of the training or input 416 to be classified after ANN 405 is trained, is provided to a corresponding node 406 in the first layer or input layer of ANN 405. The values propagate through the layers and are changed by the objective function.

As noted, the set of processing nodes is arranged to train the neural network to create a trained neural network. After the ANN is trained, data input into the ANN will produce valid classifications 420 (e.g., the input data 416 will be assigned into categories), for example. The training performed by the set of processing nodes 406 is iterative. In an example, each iteration of the training the ANN 405 is performed independently between layers of the ANN 405. Thus, two distinct layers may be processed in parallel by different members of the set of processing nodes. In an example, different layers of the ANN 405 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 406 (e.g., neurons) are trained independently. In an example, the nodes are trained on different hardware.

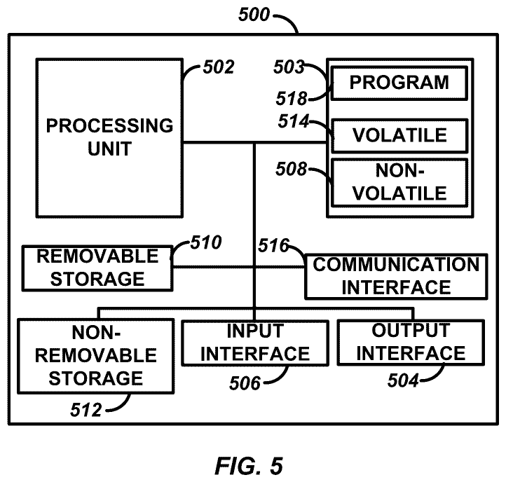

FIG. 5 is a block schematic diagram of a computer system 500 to perform search request routing, and for performing methods and algorithms according to example embodiments. Any of the components of the system 100, 200, method 300, or other component or operation can be implemented using the system 500 or a component thereof. All components of the system 500 need not be used in various embodiments.

One example computing device in the form of a computer 500 may include a processing unit 502, memory 503, removable storage 510, and non-removable storage 512. Although the example computing device is illustrated and described as computer 500, the computing device may be in different forms in different embodiments. For example, the computing device may instead be a smartphone, a tablet, smartwatch, smart storage device (SSD), or other computing device including the same or similar elements as illustrated and described with regard to FIG. 5. Devices, such as smartphones, tablets, and smartwatches, are generally collectively referred to as mobile devices or user equipment.

Although the various data storage elements are illustrated as part of the computer 500, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 503 may include volatile memory 514 and non-volatile memory 508. Computer 500 may include—or have access to a computing environment that includes—a variety of computer-readable media, such as volatile memory 514 and non-volatile memory 508, removable storage 510 and non-removable storage 512. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 500 may include or have access to a computing environment that includes input interface 506, output interface 504, and a communication interface 516. Output interface 504 may include a display device, such as a touchscreen, that also may serve as an input device. The input interface 506 may include one or more of a touchscreen, touchpad, mouse, keyboard, camera, one or more device-specific buttons, one or more sensors integrated within or coupled via wired or wireless data connections to the computer 500, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 500 are connected with a system bus 520.

Computer-readable instructions stored on a computer-readable medium are executable by the processing unit 502 of the computer 500, such as a program 518. The program 518 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 518 along with the workspace manager 522 may be used to cause processing unit 502 to perform one or more methods or algorithms described herein.

### Examples and Additional Notes

Example 1 includes a personally-stylized content generation method comprising receiving a first request for first content to be stylized in a style of written prose previously produced by a user, applying a previously trained retriever model to the first request to obtain second content previously produced by the user resulting in obtained content, populating a prompt with the obtained content and the first request resulting in an augmented prompt, providing the augmented prompt to a large language model (LLM), receiving personally-stylized content from the LLM, the personally-stylized content including elements of the style of the written prose of the user, and providing the personally-stylized content to the user.

In Example 2, Example 1 further includes training the retriever model by generating, by a language model (LM) and based on target content that is stylized in the voice of the user, content previously generated by the user, and a second request for the target content, a first score indicating how much the previously generated content will help the LLM in generating the target content, and altering the retriever model based on the first score.

In Example 3, Example 2 further includes, wherein training the retriever model further includes generating, by the language model and based on the target content that is stylized in the voice of the user and the second request for the target content, a second score indicating how well the LLM can generate the target content based on just the second request, and wherein altering the retriever model includes altering the retriever model based on the first score and the second score.

In Example 4, Example 3 further includes, wherein training the retriever model further includes generating, by the retriever model and based on the second request and the content previously generated by the user, a third score, and altering the retriever model based on a loss that considers (i) the third score and (ii) a fourth score that is a difference between the first score and the second score.

In Example 5, Example 4 further includes, wherein altering the retriever model includes using a relative entropy loss function.

In Example 6, Example 5 further includes, wherein the relative entropy loss function operates based on calibrated third scores and fourth scores that helps ensure the third score is predictive of how well the previously generated content will help the generative language generate the personally-stylized content.

In Example 7, Example 6 further includes, wherein the calibrated third scores include all the scores corresponding to the historical content and an additional zero score.

In Example 8, at least one of Examples 3-7 further includes, wherein the second request is reverse engineered based on the target content resulting in training or testing data.

In Example 9, at least one of Examples 1-8 further includes, wherein the LLM is a generative LLM.

In Example 10, at least one of Examples 1-9 further includes, wherein the retriever model is an encoder model.

In Example 11, at least one of Examples 1-10 further includes, wherein the personally-stylized content includes emulation of a writing style or communication style in the second content.

Example 12 includes a personally-stylized content generation system comprising a database storing content items previously generated by users, a pre-trained retriever model configured to receive, from a user, a query for personally-stylized content, score each item of content generated by the user in the database, and provide a specified number of content items that were previously generated by the user and associated with highest scores, a prompt augmenter configured to receive the specified number of content items, augment a prompt to include content of the specified number of content items resulting in an augmented prompt, and provide the augmented prompt to a large language model (LLM), and an application configured to provide, to the user, personally-stylized content from the LLM responsive to the augmented prompt.

In Example 13, Example 12 further includes, wherein the LLM is a generative LLM.

In Example 14, at least one of Examples 12-13 further includes, wherein the retriever model is an encoder model.

In Example 15, at least one of Examples 12-14 further includes, wherein the personally-stylized content includes emulation of a writing or communication style in the previously generated content.

In Example 16, at least one of Examples 12-15 further includes a language model configured to generate, based on target content that is stylized in a voice of the user, content previously generated by the user, and a second request for the target content, a first score indicating how much the previously generated content will help the LLM in generating the target content, and generate, based on the target content that is stylized in the voice of the user and the second request for the target content, a second score indicating how well the LLM can generate the target content based on just the second request.

In Example 17, Example 16 further includes, wherein the retriever model is further configured to generate, based on the second request and the content previously generated by the user, a third score and the system further comprises a compute device configured to alter the retriever model based on a difference between (i) the third score and (ii) a difference between the first score and the second score.

Example 18 includes a non-transitory machine-readable medium including instructions that, when executed by a machine, cause the machine to perform operations for generating personally-stylized content, the operations comprising receiving a first request for personally-stylized content from a user, providing a retriever model with the first request, receiving, from the retriever model and responsive to the first request, content previously generated by the user resulting in obtained content, populating a prompt with the obtained content resulting in an augmented prompt, providing the augmented prompt to a large language model (LLM), receiving the personally-stylized content from the LLM, and providing the personally-stylized content to the user.

In Example 19, Example 18 further includes, wherein the personally-stylized content includes emulation of a writing or communication style in the previously generated content.

In Example 20, at least one of Examples 18-19 further includes, wherein the retriever model is trained to obtain previously generated content that is most likely to help the LLM emulate the previously generated content.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine. Thus, a module can include software, hardware that executes the software or is configured to implement a function without software, firmware, or a combination thereof.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A personally-stylized content generation method comprising:
receiving a first request for first content to be stylized in a style of written prose previously produced by a user;
applying a previously trained retriever model to the first request to obtain second content previously produced by the user resulting in obtained content;
populating a prompt with the obtained content and the first request resulting in an augmented prompt;
providing the augmented prompt to a large language model (LLM);
receiving personally-stylized content from the LLM, the personally-stylized content including elements of the style of the written prose of the user; and
providing the personally-stylized content to the user.

2. The method of claim 1, further comprising:
training the retriever model by:
generating, by a language model (LM) and based on target content that is stylized in the voice of the user, content previously generated by the user, and a second request for the target content, a first score indicating how much the previously generated content will help the LLM in generating the target content; and
altering the retriever model based on the first score.

3. The method of claim 2, wherein training the retriever model further includes:
generating, by the LM and based on the target content that is stylized in the voice of the user and the second request for the target content, a second score indicating how well the LLM can generate the target content based on just the second request; and
wherein altering the retriever model includes altering the retriever model based on the first score and the second score.

4. The method of claim 3, wherein training the retriever model further includes:
generating, by the retriever model and based on the second request and the content previously generated by the user, a third score; and
altering the retriever model based on a loss that considers (i) the third score and (ii) a fourth score that is a difference between the first score and the second score.

5. The method of claim 4, wherein altering the retriever model includes using a relative entropy loss function.

6. The method of claim 5, wherein the relative entropy loss function operates based on calibrated third scores and fourth scores that helps ensure the third score is predictive of how well the previously generated content will help the generative language generate the personally-stylized content.

7. The method of claim 6, wherein the calibrated third scores include all the scores corresponding to the historical content and an additional zero score associated with an additional “anchor” content example.

8. The method of claim 3, wherein the second request is reverse engineered based on the target content resulting in training or testing data.

9. The method of claim 1, wherein the LLM is a generative LLM.

10. The method of claim 1, wherein the retriever model is an encoder model.

11. The method of claim 1, wherein the personally-stylized content includes emulation of a writing style or communication style in the second content.

12. A personally-stylized content generation system comprising:
a database storing content items previously generated by users;
a pre-trained retriever model configured to:
receive, from a user, a query for personally-stylized content;
score each item of content generated by the user in the database; and
provide a specified number of content items that were previously generated by the user and associated with highest scores;
a prompt augmenter configured to:
receive the specified number of content items;
augment a prompt to include content of the specified number of content items resulting in an augmented prompt; and
provide the augmented prompt to a large language model (LLM); and
an application configured to provide, to the user, personally-stylized content from the LLM responsive to the augmented prompt.

13. The system of claim 12, wherein the LLM is a generative LLM.

14. The system of claim 12, wherein the retriever model is an encoder model.

15. The system of claim 12, wherein the personally-stylized content includes emulation of a writing or communication style in the previously generated content.

16. The system of claim 12 further comprising:
a language model configured to:
generate, based on target content that is stylized in a voice of the user, content previously generated by the user, and a second request for the target content, a first score indicating how much the previously generated content will help the LLM in generating the target content; and
generate, based on the target content that is stylized in the voice of the user and the second request for the target content, a second score indicating how well the LLM can generate the target content based on just the second request.

17. The system of claim 16, wherein the retriever model is further configured to generate, based on the second request and the content previously generated by the user, a third score and the system further comprises:
a compute device configured to alter the retriever model based on a difference between (i) the third score and (ii) a difference between the first score and the second score.

18. A non-transitory machine-readable medium including instructions that, when executed by a machine, cause the machine to perform operations for generating personally-stylized content, the operations comprising:
receiving a first request for personally-stylized content from a user;
providing a retriever model with the first request;
receiving, from the retriever model and responsive to the first request, content previously generated by the user resulting in obtained content,
populating a prompt with the obtained content resulting in an augmented prompt,
providing the augmented prompt to a large language model (LLM);
receiving the personally-stylized content from the LLM; and
providing the personally-stylized content to the user.

19. The non-transitory machine-readable medium of claim 18, wherein the personally-stylized content includes emulation of a writing or communication style in the previously generated content.

20. The non-transitory machine-readable medium of claim 18, wherein the retriever model is trained to obtain previously generated content that is most likely to help the LLM emulate the previously generated content.
